(19) United States
(12) Patent Application Publication
(10) Pub. No.: US 2026/0261846 A1
(43) Pub. Date: Sep. 3, 2026

(54) REQUESTING ACCESS POINT CAPABILITIES AND OPERATION PARAMETERS IN ENHANCED PRIVACY WIRELESS NETWORKS

(71) Applicant: Cisco Technology, Inc., San Jose, CA (US)

(72) Inventors: Binita GUPTA, San Diego, CA (US); Brian D. HART, Sunnyvale, CA (US); Jerome HENRY, Pittsboro, NC (US)

(21) Appl. No.: 19/553,175

(22) Filed: Feb. 27, 2026

Related U.S. Application Data
(60) Provisional application No. 63/766,271, filed on Mar. 3, 2025.
(60) Provisional application No. 63/766,248, filed on Mar. 3, 2025.

(51) Int. Cl. H04W 12/02; H04W 8/22

(52) U.S. Cl. CPC H04W 12/02; H04W 8/22

(57) ABSTRACT

The present disclosure provides techniques for identifying and transmitting values related to a capability or operation parameter of an Enhanced Privacy Protection (EPP) access point, including receiving, by a first AP and from a first wireless station associated to the first AP, a protected wireless management request frame, where the request frame includes a request that identifies at least one link of the first AP and at least one capability or operation parameter of the at least one link. The first AP may determine, based on the request, a set of values for the at least one capability or operation parameter of the at least one link. The first AP may encode a protected wireless management response frame, wherein the protected wireless management response frame includes the set of values for the at least one link, and may transmit the protected wireless management frame to the first wireless station.

### CROSS-REFERENCE TO RELATED APPLICATIONS

This application claims benefit of co-pending United States provisional patent application Serial No. 63/766,271 filed March 3, 2025 and. co-pending United States provisional patent application Serial No. 63/766,248 filed March 3, 2025. The aforementioned related patent applications are herein incorporated by reference in their entirety.

### TECHNICAL FIELD

Embodiments presented in this disclosure generally relate to wireless networks. More specifically, embodiments disclosed herein relate to providing a wireless station with capability and operation parameter values for an enhanced privacy protection access point.

### BACKGROUND

Modern wireless networks may employ a number of security features aimed at enhancing the security of the network and its clients. The Institute of Electrical and Electronics Engineers (IEEE) 802.11bi amendment, referred to as the Enhanced Privacy Protection (EPP) amendment, establishes a set of privacy protection enhancements for clients (e.g., non-access point (AP) multi-link devices (MLDs)) and AP MLDs that enable clients and AP MLDs to preserve privacy and avoid outside tracking of the network and clients of the network. As a part of these amendments, IEEE has established an “EPP capabilities and operation parameters request,” and corresponding “EPP capabilities and operation parameters response” procedure, that enable a wireless station (STA) to request capabilities and operation parameters from an EPP enabled access point (AP) or an EPP AP MLD. An EPP AP or AP MLD, as described herein, supports Enhanced Privacy Protection (EPP) features defined in 802.11bi.

In response to receiving a request, the EPP AP or AP MLD may return the response to the requesting STA (e.g., a non-AP MLD). However, the EPP capabilities and operation parameters response frame defined in the 802.11bi standard is configured to return all the elements that are included in a standard Probe Response frame, except for select elements for multi-link (ML) APs (for AP MLD case). Also, for an AP MLD, the response frame is defined to provide information for all the links of the AP MLD and for each link is configured to return all the elements that are included in a standard Probe Response frame. As a result, the response frame may be extremely large in size, adding significant network overhead.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for wireless network management, according to some embodiments of the present disclosure.

FIG. 2 depicts an example environment for identifying capability and operation parameter values for an EPP AP or AP MLD, according to some embodiments of the present disclosure.

FIG. 3 is a flow diagram depicting an example method for identifying and transmitting capability and operation parameter values for a non-MLO EPP AP, according to some embodiments of the present disclosure.

FIG. 4 is a flow diagram depicting an example method for identifying and transmitting capability and operation parameter values for an EPP AP MLD, according to some embodiments of the present disclosure.

FIG. 5 is a flow diagram depicting an example method for determining what capabilities and/or operation parameter values to provide in response to receiving a request for an EPP AP MLD, according to some embodiments of the present disclosure.

FIG. 6 is a flow diagram depicting an example method for identifying capability and operation parameter values for an EPP AP in the same Basic Service Set of a requesting wireless STA, according to some embodiments of the present disclosure.

FIG. 7 is a flow diagram depicting an example method for identifying capability and operation parameter values for a neighboring EPP AP in a different Basic Service Set than a requesting wireless STA, according to some embodiments of the present disclosure.

FIG. 8 depicts an example computing device configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method. The method includes: receiving, by a first access point (AP) and from a first wireless station associated to the first AP, a protected wireless management request frame, wherein the first AP is an Enhanced Privacy Protection (EPP) AP, and wherein the protected wireless management request frame includes a request that identifies at least one link of the first AP and at least one capability or operation parameter of the at least one link; determining, by the first AP and based on the request, a set of values for the at least one capability or operation parameter of the at least one link of the first AP; encoding, by the first AP, a protected wireless management response frame, wherein the protected wireless management response frame includes the set of values for the at least one link of the first AP; and transmitting, by the first AP, the protected wireless management response frame to the first wireless station of the BSS.

Another embodiment presented in this disclosure provides a second method. The second method includes: implementing, by a first access point, a basic service set (BSS) for one or more wireless stations, wherein an Extended Service Set (ESS) includes the first access point (AP) and a second AP neighboring the first AP, and the first AP and the second AP are Enhanced Privacy Protection (EPP) APs, wherein each of the first AP and the second AP have a set of capabilities and operation parameters; receiving, by the first AP and from a first wireless station of the BSS, a protected wireless management request frame, wherein the protected wireless management request frame includes a request that identifies at least one link of the second AP and at least one capability or operation parameter of the at least one link; determining, by the first access point and based on the request, a set of values for the at least one capability or operation parameter of the at least one link of the second AP; encoding, by the first AP, a protected wireless management response frame, wherein the protected wireless management response frame includes the set of values for the at least one link of the second AP; and transmitting, by the first AP, the protected wireless management response frame to the first wireless station of the BSS.

Other embodiments provide an access point comprising one or more memories and one or more processors communicatively coupled to the one or more memories, wherein the one or more processors are configured to, individually or collectively, perform either of the aforementioned methods, as well as those described herein.

### Example Embodiments

In some embodiments of the present disclosure, techniques are provided to identify specific capabilities and/or operation parameters for one or more Enhanced Privacy Protection (EPP) enabled APs.

As discussed above, in modern EPP enabled networks, wireless STAs may transmit a Capabilities and Operation Parameter request to an AP, which requests information related to an EPP AP of an Extended Service Set (ESS) (e.g., an AP associated with the wireless STA, a neighboring AP, etc.). However, the Capabilities and Operation Parameter response is configured to return values associated with each capability and operation parameter, regardless of whether the wireless STA wants and/or needs each included value. That is, A STA (or non-AP MLD) may only be interested in requesting a specific subset of capabilities and operation parameters an AP, and/or capabilities and operation parameters of a subset of links of an AP MLD but may receive values for the total set of capabilities and operation parameters for all links instead. As a result, the response frame may be extremely large in size, adding significant network overhead and waste as unneeded values are transmitted to the wireless STA.

Embodiments of the present disclosure provide methods, systems, and apparatuses for providing a set values associated with a set of the capabilities and operation parameters based on a request from a wireless STA. More specifically, some embodiments are directed towards techniques that enable a wireless STA to identify specific capabilities and/or operation parameter for which the wireless STA wants to receive values. Based on the specific set of capabilities and/or operation parameters requested by the STA, an EPP AP may determine a set of respective values, which can be transmitted to the STA. The techniques, as described below, may correspond to a plethora of different types of APs, including EPP APs associated with the STA, EPP APs in a different BSS from the STA, EPP AP multi-link devices (MLDs), and non-multi-link operation (MLO) EPP APs. Accordingly, such techniques enable a STA to request and receive only the needed and/or wanted values from an AP, reducing the size of the response frame and network overhead. The phrases and acronyms related to Enhanced Privacy Protection (EPP), Enhanced Data Privacy (EDP) and Basic Service Set (BSS) privacy enhancements (BPE), as discussed above, may be used interchangeably throughout this application. That is, an EPP AP may be interchangeably referred to as a BPE AP, and so forth.

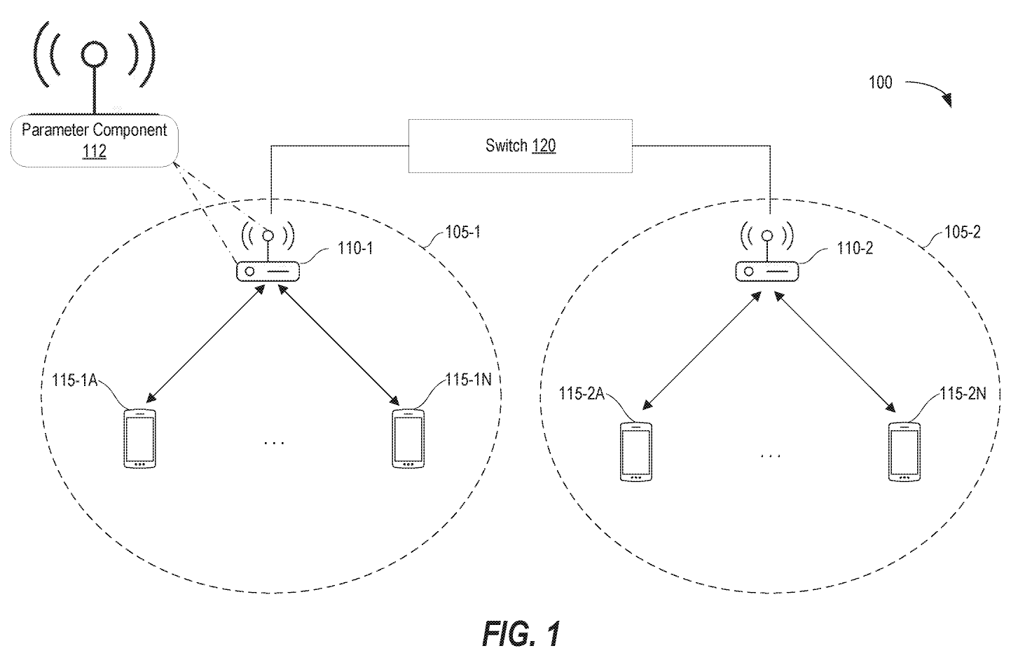

FIG. 1 depicts an example wireless environment 100 in which embodiments of the present disclosure may be implemented. As depicted, the environment 100 includes multiple Basic Service Sets 105-1 and 105-2 (collectively, “BSSs 105”), connected by a switch 120 to form an Extended Service Set. Although the Extended Service Set of FIG. 1 is depicted as including only two BSSs, any number of BSSs may be included in other implementations.

Each of the BSSs 105 may include an AP, such as an AP 110-1 and an AP 110-2 (collectively, “APs 110”). Each AP 110 may generally correspond to an access point used to facilitate or provide connectivity in a wireless network (e.g., a wireless local area network (WLAN), e.g., using Wi-Fi protocols) and implement a BSS. Each respective AP 110 may be identified throughout the ESS with a respective unique BSSID, which wireless STAs may use to connect to and send data throughout a corresponding BSS.

Each of the APs 110 may be configured to provide wireless access to one or more wireless STAs (e.g., client devices), such as a collection of STAs 115-1A through STAs 115-1N or a collection of STAs 115-2A through STAs 115-2N (collectively, “STAs 115”). Each of STAs 115 may generally be representative of any computing device capable of wireless communications using the WLAN, such as a smartphone, tablet, laptop, wearable computing device (e.g., smartwatch), and the like.

Each of the APs 110 may be associated with any number of the associated set of STAs 115 for active wireless data communications. For example, as depicted, the STA 115-1A is associated with the AP 110-1. In some embodiments, each of the APs 110 may be concurrently connected to any number of client devices. In some embodiments, each AP 110 may operate as a single-link AP or as a multi-link or multi-link device (MLD) AP, and each STA 115 may operate as a single-link station (STA) or as an MLD STA. For example, where the AP 110-1 is an AP MLD, the AP 110-1 may simultaneously operate a multitude of links across multiple frequency bands, such as 2.4 GHz, 5 GHz, and 6 GHz. In some embodiments, each of the APs 110 may be a BPE-capable AP, such that the AP is capable of implementing BSS privacy enhancement techniques, as described above.

As described herein, any of the STAs 115 may communicate with an associated AP to request and/or receive capability and operation parameter information related to an EPP AP in the ESS. For example, the STA 115-1A may send an EPP capability and operation parameters request to the AP 110-1 for information related to at least one link of the AP 110-1 (e.g., one AP of the AP 110-1 if the AP 110-1 is an AP MLD having multiple discrete APs). As another example, the STA 115-1A may send an EPP capability and operation parameters request to the AP 110-1 for information related to at least one link of an AP in a neighboring BSS, such as the AP 110-2 of the BSS 105-2. In conventional systems, upon receiving the request, the AP 110-1 may respond to both requests by providing values and details regarding each capability and operation parameter associated with the AP identified in the request. That is, even if the STA 115-1A desires only a small subset of the total capabilities and operation parameters, the AP 110-1 may provide information for the total set. Additionally, wherein the AP 110-1 is an AP MLD, even if the STA 115-1A desires only capability and operation parameter information for a single link of the AP 110-1, the AP 110-1 may provide information on each link of the AP 110-1.

However, the APs 110, using embodiments of the present disclosure, may provide a subset of the total set of capabilities and operation parameters to a requesting station. That is, each of the APs 110 may include a parameter component 112, as shown in a detailed view of the AP 110-1 in FIG. 1. The parameter component 112 may enable a wireless STA (e.g., any of the STAs 115) to identify a set of capabilities and/or operation parameters that the requesting station wishes to receive information on. For example, STA 115-1A may send an EPP capability and operation parameters request to the AP 110-1 indicating that the STA 115-1A only wants to receive information related to the BSS load of the AP 110-1. In response to receiving the request, the parameter component 112 may process the request and may determine only a value related to the BSS load of the AP 110-1. Additionally, the parameter component 112 may enable a wireless STA (e.g., any of the STAs 115) to identify a subset of links of an AP MLD for which the requesting station wishes to receive capabilities and operation parameters information on. In this way, the parameter component 112 may enable the APs 110 to generate and transmit capability and operation parameters responses comprising specific sets of capabilities and operation parameters, and/or specific sets of capabilities and operation parameters for specific links of an AP MLD, enabling the APs 110 to reduce the size of a response frame and network overhead.

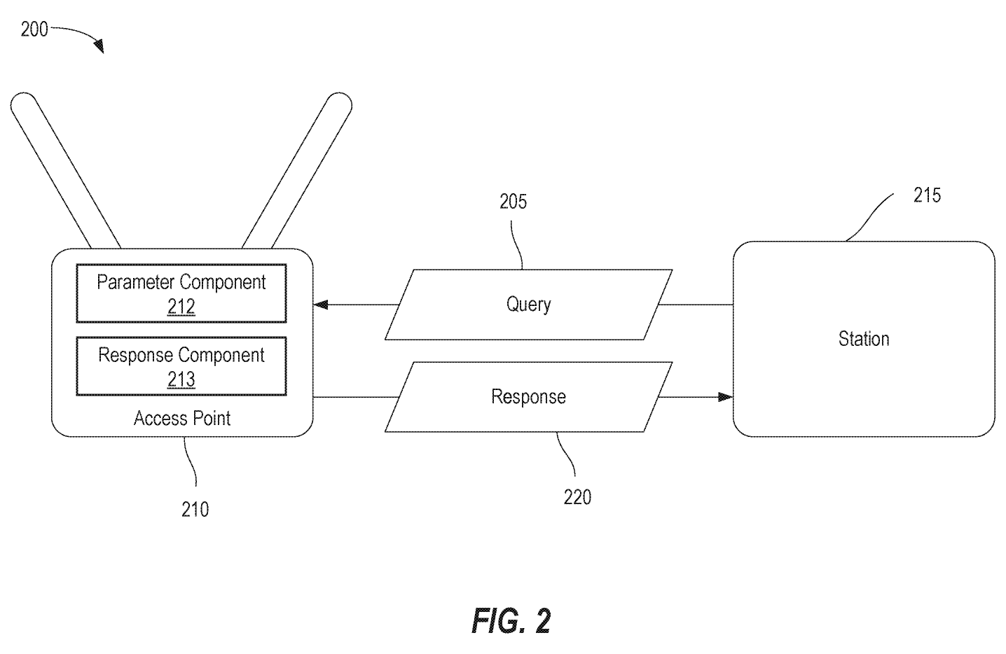

FIG. 2 depicts an example environment 200 for identifying capability and operation parameters values for an EPP AP or AP MLD, according to some embodiments of the present disclosure. In the illustrated example, an AP 210 (which may correspond to one of the APs 110 of FIG. 1) is communicatively coupled with a STA 215 (which may correspond to one of the STAs 115 of FIG. 1), such as via a WLAN (e.g., a Wi-Fi network). That is, the AP 210 and the STA 215 may correspond to any of the APs 110 of FIG. 1 and an associated STA of the STAs 115, respectively, such that the AP 210 and the STA 215 may be a part of the same BSS, which in turn may be a part of a larger ESS.

In the environment 200, the STA 215 transmits a query 205 to the AP 210. For example, the STA 215 may transmit the query 205 via a management request frame. The query 205 may generally correspond to, or comprise, a request for the AP 210 to provide information to the STA 215 regarding at least one capability or operation parameter of at least one link of an AP, such as an EPP capability and operation parameters request. For example, the query 205 may comprise a protected (e.g., by a service, such as a Protected Management Frame (PMF) service) management request frame including an EPP capability and operation parameters request requesting information on a link of the AP 210 (or of a neighboring AP in the ESS).

To specify or otherwise identify an individual or set of capabilities and/or operation parameters for which information is requested on, the query 205 may include a request element and/or an extended request element, which identifies at least one capability or operation parameter. That is, each potential capability or operation parameter that may be queried may be specified in one of the request element or the extended request element. Accordingly, depending on the capabilities and/or operation parameters for which values are being requested, the query 205 may include a request element, an extended request element, or both elements, as needed to identify each capability and operation parameter for which values are being requested. In some examples, such as when the query 205 includes a request element and/or extended request element, the query 205 may include a flag indicating that only a subset of the total available capabilities and operation parameters are provided. Similarly, in some examples, such as where the query 205 does not include a request element or an extended request element, the query 205 may include a flag indicating a full profile request, such that the AP 210 should provide a set of values related to each capability and operation parameter of the total available set of capabilities and operation parameters (for the specified link(s)).

The parameter component 212 may generally correspond, and operate in a similar manner to, the parameter component 112 of FIG. 1. The parameter component 212 may analyze the query 205 to determine what values need to be determined and included in the response 220 to the STA 215. That is, the parameter component 212 may analyze the query 205, and information therein (e.g., a request element, an extended request element, an indication flag, etc.) to determine a set of capabilities and/or operation parameters for which the parameter component 212 should determine values.

In some examples, the set of capabilities and/or operation parameters that the parameter component 212 will determine values for is based directly on the query 205, such that the parameter component 212 determines values only for the capabilities and/or operation parameters identified in the query 205. However, in other examples, the parameter component 212 may include additional capabilities and/or operation parameters. For example, when the query 205 includes an extended request element identifies only one operation parameter, the parameter component 212 may determine that there are additional values that may be useful for the STA 215 to know, such as when the values have changed from the values determined as a result a prior query (e.g., at a previous time).

As discussed above, in some examples, the query 205 may request data related to a single link (e.g., non-ML) EPP AP, such that a link of the AP need not be specified. However, in other examples, the query 205 may request data related to an EPP AP MLD (e.g., an AP with multiple links), such that the query 205 may specify a link, or set of links, of the AP for which information is requested. In such examples, the query 205 may include a basic ML element. In some examples, the ML element may include an indication flag representing whether the STA 215 is requesting data pertaining to all links of the identified AP. In other examples, the ML element may include one or more per-STA profiles, wherein each per-STA profile identifies a specific link of the AP 210. For example, the query 205 may comprise a protected management request frame including an EPP capability and operation parameters request requesting information on the AP 210, wherein the AP 210 is an EPP AP MLD. The query 205 may include an ML element, including a per-STA profile identifying a 5GHz link of the AP 210 (e.g., by a link identifier) and a second per-STA profile identifying a 2.4GHz link of the AP 210.

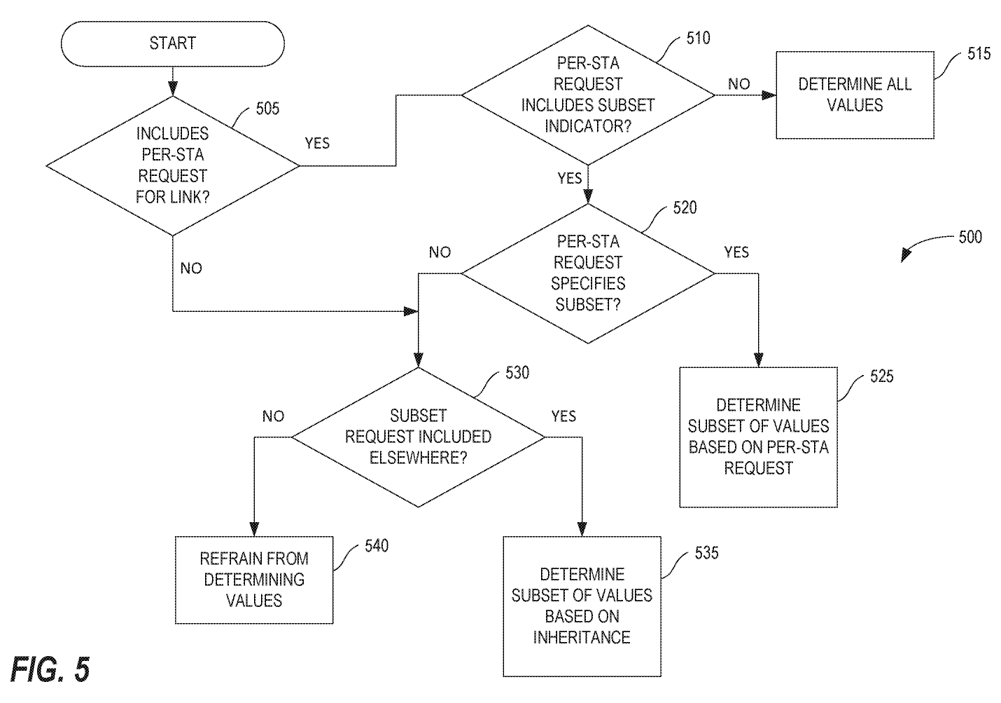

Furthermore, each per-STA profile may include an indication flag representing whether the STA 215 is requesting values for all capabilities and operation parameters of the associated link (e.g., the full profile of the specified link), or a subset of capabilities and/or operation parameters. In such examples where the per-STA requests a subset of capabilities and/or operation parameters, in some examples, the per-STA profile may include the request element and/or extended request element, as discussed above, while in other examples, the request element and/or extended request element may be included generally in the query 205 (e.g., inside of the request frame itself), but outside of the per-STA profiles and/or the ML element. Additionally, in some examples, a request element and/or extended request element may only be included once in the query 205, such that per-STA profiles may inherit the request element and/or extended request element without needing to restate the requested information. As another example, a first per-STA profile may specify the subset of desired elements (e.g., using a request element and/or extended request element), and a second per-STA profile may not include a subset of desired elements, and instead inherit the elements requested in the first per-STA profile. As another example, the subset of desired elements may be included in the frame in general (e.g., in an ML element), such that each per-STA profile included in the frame may inherit the subset of desired elements. Additional details regarding the formatting of requests and responses for EPP AP MLDs are discussed below, with reference to FIG. 5.

As discussed above, the query 205 may identify the AP 210 (e.g., the AP in which the STA 215 is connected to and associated with) as the target for the EPP capabilities and operation parameters request. However, in some examples, the target AP may be a neighboring AP (e.g., any of the APs 110 of FIG. 1 residing in a different BSS than the STA 215). For example, wherein the AP 210 represents the AP 110-1 of FIG. 1, and wherein the STA resides within the BSS 105-1, the STA may identify the AP 110-2 of the BSS 105-2 as the target for the request. That is, the query 205 may include an identifier (e.g., a BSSID) identifying a neighboring EPP AP for which information is requested. In such examples wherein the query 205 specifies a neighboring EPP AP, the query 205 may include a neighbor report element, wherein the neighbor report element may include one or more of the elements discussed above, such as an ML element, a request element, or an extended request element. However, in some examples, the query 205 may include the one or more elements discussed above without including a neighbor report element, such that the additional elements include are extended or otherwise modified to include identification information regarding the neighboring AP.

Additionally, although as described thus far with respect to only a single EPP AP, the query 205 may identify multiple EPP APs for which information is requested. For example, wherein the AP 210 corresponds to the AP 110-1 of FIG. 1, the query 205 may include a request for information on both one or more links of the AP 210 and one or more links of a neighboring EPP AP, such as the AP 110-2 of FIG. 1. Accordingly, the query 205 may contain multiple of the elements as discussed above, such as an ML element of a neighbor element, associated with each of the links of the APs for which information is being requested.

The response component 213 of the AP 210 may encode one or more response frames, such as a wireless management response frame, which includes the values identified by the parameter component 212. The response component 213 may include, in the encoded frames, one or more of the elements discussed above, such as an ML element, wherein values for each requested link of the identified AP may be included in a per-STA profile. The AP 210 may transmit the one or more frames, collectively, as the response 220, to the STA 215. In some examples, the response 220 may include additional details, information, and the like, such as beacon interval information or general capability information.

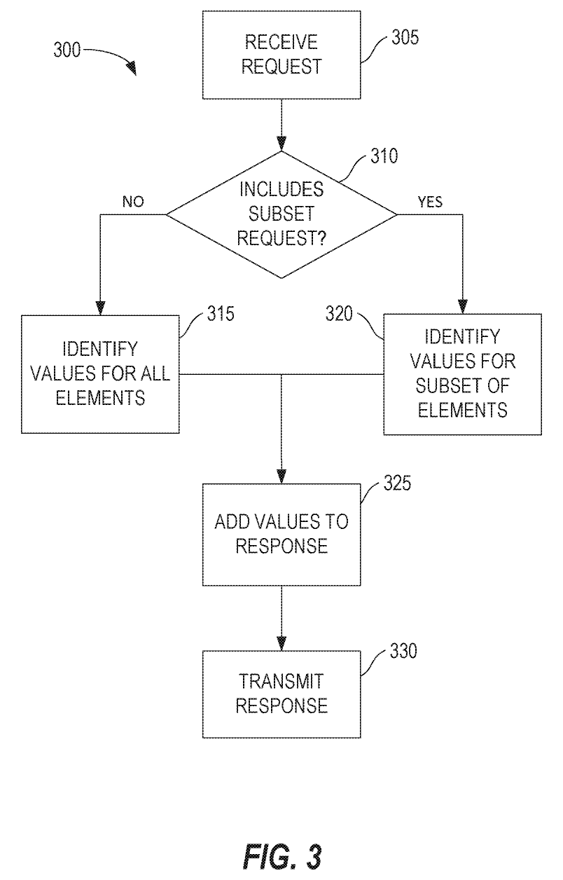

FIG. 3 depicts an example method 300 for identifying and transmitting capability and operation parameter values for a non-MLO EPP AP, according to some embodiments of the present disclosure. The example method 300 may be performed by an AP, such as one of the APs 110 of FIG. 1 or the AP 210 as depicted in FIG. 2.

At block 305, an AP (e.g., one of the APs 110 of FIG. 1 or the AP 210 as depicted in FIG. 2) receives a request (e.g., the query 205 of FIG. 2) from a wireless STA (e.g., one of the STAs 115 of FIG. 1 or the STA 215 of FIG. 2). More specifically, the AP may receive a request for the values of one or more capabilities and/or operation parameters of a non-MLO (e.g., single link) EPP device. In some examples, the request may identify a link of the AP receiving the request. In some embodiments, the request may additionally or alternatively identify a link of a neighboring (e.g., alternative) AP. As depicted in the example method 300 of FIG. 3, the request only identifies one link of one AP. However, in other examples, the request may identify a link of multiple APs for which information is requested, such that blocks described herein, such as blocks 310, 315, 320, and 325, may be repeated for each link identified in the request. In some examples, such as where the target AP is a neighboring AP, the STA may include a known BSS Parameters Change Count (BPCC) in the request.

At block 310, the AP, or a component therein (e.g., the parameter component 112 of FIG. 1 or the parameter component 212 of FIG. 2), determines whether the request includes a request for a subset of the total set of capabilities and operation parameters. That is, the AP determines whether the request is a full profile request, such that the request is for values related to the total set of capabilities and operation parameters, or whether the request is for a subset of the available capabilities and operation parameters. The AP may determine the requested capabilities and operation parameters based on one or more indication flags and/or elements included in the request. For example, the AP may determine that the request includes a request element and/or an extended request element, identifying specific capabilities and/or operation parameters for which values are requested.

If the AP determines that the request is for the total set of elements of the capabilities and operation parameters, the AP may proceed according to the “NO” branch to block 315. At block 315, the AP identifies values for each capability and operation parameter of the identified AP. As one example, wherein the request identified the AP as the target, the AP may determine a value for each capability and operation parameter of itself using internal data and metrics. As another example, wherein the requested a neighboring AP as the target, the AP may determine a value for one or more of the total capabilities and operation parameters of the neighboring AP by interacting with one or more external devices, such as the neighboring AP itself or a controller entity, such as a WLAN controller (WLC). However, in some examples, the AP may determine the values for one or more of the total capabilities and operation parameters of the neighboring AP based on cached information at the AP (e.g., based on a previous communication with the WLC and/or the neighboring AP).

If the AP determines that the request is for a subset of elements of the total set of capabilities and operation parameters, the AP may proceed according to the “YES” branch to block 320. At block 320, the AP determines what subset of elements are to be transmitted to the STA and determines values for each. In some examples, the AP may determine what subset of elements to include in the response back to the STA based only on the request, such that the AP may only determine values for the elements requested. For example, wherein the request includes an extended request element requesting only a value for the BSS Load of the target AP, the AP may determine a value only for the BSS Load. However, in other examples, the AP may determine what subset of capabilities and/or operation parameters to include values for based on additional factors, such that the AP may include values for capabilities and/or operation parameters not requested by the STA. For example, the AP may receive a request including an extended request element requesting only a value for the BSS Load of the target AP. However, the AP may use cached information to determine that the STA previously requested info on the usage of a certain channel, and that the value has changed since the AP last provided the information. Accordingly, the AP may decide to include the current usage value for the channel in the response as well. In some examples, where a BPCC is present in the request, the AP may filter the set of parameters for which values should be determined to include only the capabilities and/or operation parameters that have changed since the time indicated by the BPCC.

At block 325, the AP, or a component therein (e.g., the response component 213 of FIG. 2) adds the values to a response, such as an EPP capability and operations parameters response in a protected wireless management response frame. At block 330, the AP transmits the response to the STA.

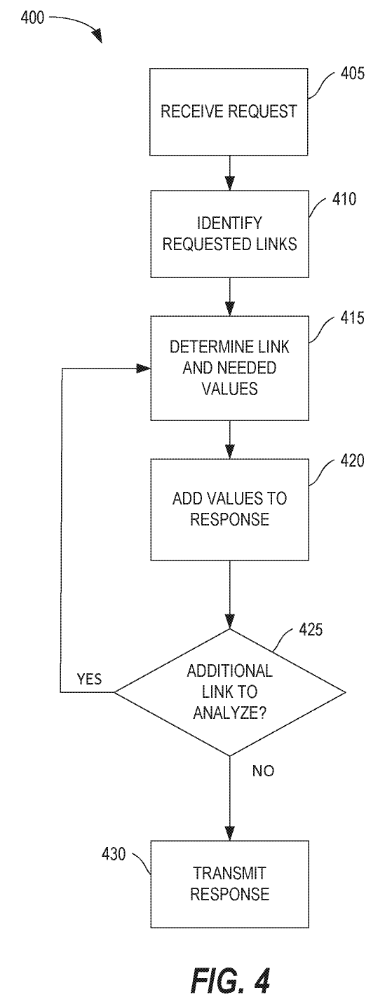

FIG. 4 depicts an example method 400 for identifying and transmitting capability and operation parameter values for an EPP AP MLD, according to some embodiments of the present disclosure. The example method 400 may be performed by an AP, such as one of the APs 110 of FIG. 1 or the AP 210 as depicted in FIG. 2.

At block 405, an EPP AP (e.g., one of the APs 110 of FIG. 1 or the AP 210 as depicted in FIG. 2) receives a request (e.g., the query 205 of FIG. 2) from a wireless STA (e.g., one of the STAs 115 of FIG. 1 or the STA 215 of FIG. 2). More specifically, the AP may receive a request for the values of one or more capabilities and/or operation parameters of an AP device. The request may include a ML element (e.g., a Basic ML element, a Probe Request ML element, a Reconfiguration ML element, a custom or enhanced ML element, and the like), which includes details regarding the link(s) for which information is being requested, such as a link identifier. In some examples, as discussed above, the request, and/or the ML element within the request, may include additional elements, such as a per-STA profile, a request element, an extended request element, or a neighbor report element. In other examples, one or more of these additional elements, such as a neighbor report element, may instead include the ML element. In some examples, such as where the target AP is a neighboring EPP AP MLD, the STA may include a known BSS Parameters Change Count (BPCC) in the request.

In some examples, the request may identify one or more links of the AP receiving the request, wherein the AP is an EPP AP MLD, while in additional examples, the request may identify one or more links of a neighboring (e.g., alternative) EPP AP MLD. for example, to indicate that the request is for a neighboring EPP AP MLD, the request may include a neighbor report element, or an additional field indicating a BSSID or MLD Media Access Control (MAC) address, such as within the Common Info field of an ML element. In some examples, the request may include one or more SSIDs in the request, to enable the AP to filter neighboring APs based on the requested SSID(s).

At block 410, the AP, or a component therein (e.g., the parameter component 112 of FIG. 1 or the parameter component 212 of FIG. 2) identifies the set of requested links of the request. That is, in some examples, the request may include no per-STA profiles, such that the AP may determine that the request is for information on each link of the target AP. In other examples, the request may include one or more per-STA profiles, wherein each per-STA profile identifies a link of the target AP (e.g., using a link identifier). In such examples, in some embodiments, the request may include a per-STA profile for each link of the target AP, such that the AP determines that each link of the target AP is in the set of requested links. In other embodiments, the request may include a per-STA profile for only a subset of links of the AP, such that the AP only identifies the links associated with each per-STA profile of the request as being in the set of requested links. As one example, the target AP broadcasts over 2.4 GHz, 5 GHz, and 6 GHz links simultaneously. The request may include only a per-STA profile identifying the 2.4 GHz link, such that the AP determines that values are only being requested for the 2.4 GHz link.

At block 415, the AP determines (e.g., selects) a link to analyze and determines what values need to be determined (e.g., at least the parameters and/or operation parameters of the request). The AP may then determine the requested values. The operations of block 415 are described in more detail below with reference to FIG. 5. At block 420, the AP, or a component therein (e.g., the response component 213 of FIG. 2) adds the values to the response.

At block 425, the AP determines whether there is an additional link to analyze. If the AP determines that there are additional links for which values need to be determined, the AP proceeds according to the “YES” branch back to block 420, at which the AP determines a new link to analyze (e.g., from the set of links for which values are requested for but have not yet been determined). If the AP has determined values associated with each link identified in the request, the AP proceeds according to the “NO” branch to block 430, at which the AP transmits the response to the STA.

As depicted in the example method 400 of FIG. 4, the request only identifies a set of links associated with one AP. However, in other examples, the request may identify a set of links of multiple EPP AP MLDs for which information is requested on (e.g., by including multiple ML elements), such that blocks described herein, such as blocks 410-425 may be repeated for each set of links for an AP, as identified in the request. In such embodiments, in some examples, such as when the response information (e.g., a response frame) is too large, the AP may be configured to transmit multiple responses in order to send the requested information to the STA.

In some examples, to enable a STA to request capability and operation information for a link of an EPP AP MLD, a new capability bit may be created (e.g., defined) in a Robust Security Network (RSN) extension element (RSNXE) (e.g., to indicate support for the techniques described herein). For example, the STA supporting this capability would send the EPP Capabilities and operation parameters request frame, as discussed above, only to a link that has the corresponding RSNXE bit set to a specific value (e.g., 1).

FIG. 5 depicts an example method 500 for determining what capabilities and/or operation parameter values to provide in response to receiving a request for values for an EPP MLD AP, according to some embodiments of the present disclosure. The method 500 provides more detail for block 415 of FIG. 4, such that each operation of the method 500 may be included in the operation of block 415 of FIG. 4 (e.g., by which the AP determines the requested values for a given link). Accordingly, the example method 500 may be performed by an AP, such as one of the APs 110 of FIG. 1 or the AP 210 as depicted in FIG. 2.

At block 505, an AP (e.g., one of the APs 110 of FIG. 1 or the AP 210 as depicted in FIG. 2) determines whether the request (e.g., the request 205 of FIG. 2) includes a per-STA profile identifying the link(s) for which values are currently being determined for. If the request does not include a per-STA profile identifying the link(s), the AP may proceed according to the “NO” branch to block 525, described below. If the request includes a per-STA profile identifying the link(s), the AP may proceed according to the “YES” branch to block 510.

At block 510, the AP determines whether the per-STA profile associated with the link(s) for which values are currently being determined includes an indicator indicating that the request is for a subset of capabilities and/or operation parameters of the link(s) (e.g., a 0), or whether the per-STA profile includes an indicator indicating that the request is for all of the capabilities and operation parameters for the link(s) (e.g., a 1). If the AP determines that the per-STA profile does not include a subset indicator (e.g., includes a full profile indicator), the AP may proceed according to the “NO” branch to 515. At block 515, the AP determines values for all capabilities and operation parameters of the link being currently analyzed.

If the AP determines that the per-STA profile does include a subset indicator the AP may proceed according to the “YES” branch to block 520. At block 520, the AP determines whether the per-STA profile specifies (e.g., includes, identifies, etc.) a subset of capabilities and/or operation parameters for which values should be determined for. For example, the AP determines whether the per-STA profile associated with the link includes a request element and/or extended request element that specify a set of capabilities and operation parameters for which values are requested. If the AP determines that the per-STA profile for the link does include a specified subset, the AP may proceed according to the “YES” branch to block 525, where the AP determines values for at least the capabilities and/or operation parameters requested in the per-STA profile. In some examples, the AP may determine values for one or more additional capabilities and/or operation parameters not requested or identified in the per-STA profile.

If the AP determines that the per-STA profile for the link does not include a specified subset, the AP may proceed according to the “NO” branch to block 530. At block 530, the AP determines whether a subset of capabilities and/or operation parameters for which values should be determined is included elsewhere in the request. As one example, the AP may determine whether the request includes an overall subset of requested capabilities and/or operation parameters, such as a request element and/or extended request element included in the request, such that the overall subset is meant to be applied to each requested link (e.g., where the request specifies that information for the same subset of capabilities and/or operation parameters be returned for each specified link). As another example, the AP may determine whether a per-STA profile of a previously analyzed link included a subset of capabilities and/or operation parameters for which values should be determined. For example, wherein a request included two per-STA profiles, a first per-STA profile may include a request for the BSS load of the associated link, while a second per-STA profile may not include or specify any capabilities or operation parameters for which the AP should determine values.

If the AP determines that there is a subset request elsewhere in the request that may be used, the AP proceeds according to the “YES” branch to block 535. At block 535, the AP uses the previous subset request to determine the set of capabilities and/or operation parameters to determine values for with respect to the link currently being analyzed. The AP then determines the associated values. In some examples, the AP may determine values for one or more additional capabilities and/or operation parameters not requested or identified in the previous subset request.

If the AP determines that there is not a subset request elsewhere in the request that may be used, the AP proceeds according to the “NO” branch to block 540. At block 540, the AP refrains from determining any values, as the AP may not be able to determine what capabilities and/or operation parameters values should be determined. Although the block 540 is depicted as refraining from determining any values, in some examples, the operations at block 540 may instead determine values for all capabilities and operation parameters of the link being currently analyzed, in order to provide the requesting STA with as much detail as possible.

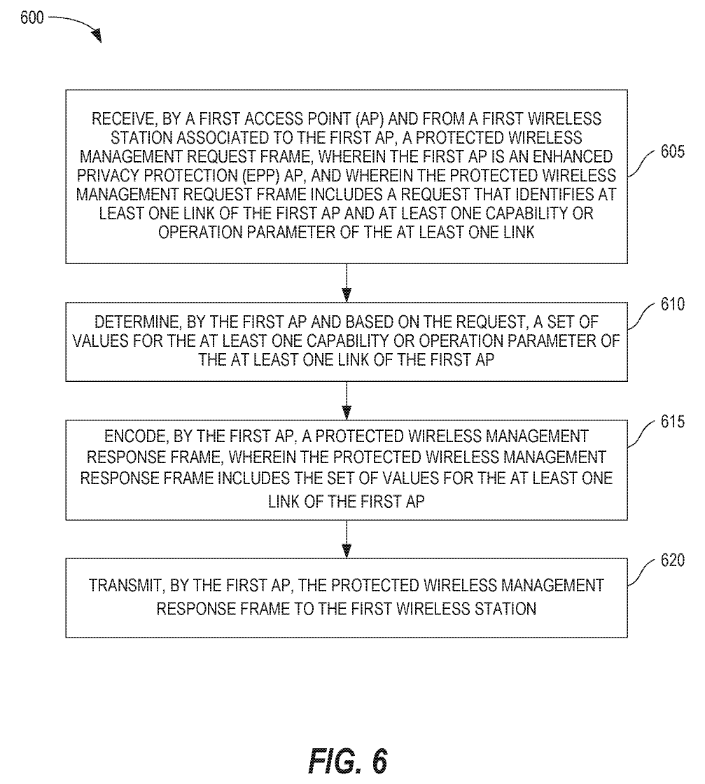

FIG. 6 depicts an example method 600 for identifying capability and operation parameter values for an EPP AP in the same BSS of a requesting wireless STA, according to some embodiments of the present disclosure. In some aspects, the method 600 is performed by an AP, such as an AP 110 of FIG. 1 and/or an AP 210 of FIG. 2.

At block 605, a first access point (e.g., any of the APs 110 of FIG. 1 and/or the AP 210 of FIG. 2) receives, from a first wireless station associated to the first AP (e.g., any of the STAs 115 in the same BSS 105 of the first AP and/or the STA 215 of FIG. 2), a protected wireless management request frame, wherein the first AP is an EPP AP, and wherein the protected wireless management request frame includes a request (e.g., the request 205 of FIG. 2) that identifies at least one link of the first AP and at least one capability or operation parameter of the at least one link. In some examples, block 605 may correspond to, or provide additional or alternative details for, the operations discussed above with reference to block 305 of FIG. 3 or block 405 of FIG. 4.

At block 610, the first AP determines (e.g., using, or in conjunction with, a component therein, such as the parameter component 112 of FIG. 1 or the parameter component 212 of FIG. 2), based on the request, a set of values for the at least one capability or operation parameter of the at least one link of the first AP. In some examples, block 610 may correspond to, or provide additional or alternative details for, the operations discussed above with reference to block 315 or block 320 of FIG. 3, or block 415 of FIG. 4 (with additional details described by blocks 505-530 of FIG. 5).

At block 615, the first AP encodes a protected wireless management response frame, wherein the protected wireless management frame includes the set of values for the at least one link of the first AP. In some examples, block 615 may correspond to, or provide additional or alternative details for, the operations discussed above with reference to block 325 of FIG. 3 or block 420 of FIG. 4.

At block 620, the first AP transmits the protected wireless management response frame (e.g., inside of, or operating as, the response 220 of FIG. 2) to the first wireless station. In some examples, block 620 may correspond to, or provide additional or alternative details for, the operations discussed above with reference to block 330 of FIG. 3 or block 430 of FIG. 4.

In some embodiments, the request includes at least one of a request element or an extended request element identifying the at least one capability or operation parameter for which the first AP should determine a value for.

In some embodiments, the request includes a flag indicating a full profile request. In such embodiments, to determine the set of values, the first AP determines a value for each capability or operation parameter of the first AP. In some examples, said operations may correspond to, or provide additional or alternative details for, the operations discussed above with reference to block 315 of FIG. 3 or block 515 of FIG. 5.

In some embodiments, the first AP is an AP MLD comprising a plurality of links. In such embodiments, the request includes at least one link of the plurality of links. In some embodiments, the request comprises an ML element that includes one or more per-STA profile sub-elements, wherein each of the one or more per-STA profile sub-elements identifies a link of the plurality of links of the first AP for which the first AP should determine a value for. In such embodiments, in some examples, each per-STA profile sub-element comprises at least one of a request element or an extended request element identifying the at least one capability or operation parameter for which the first AP should determine a value for.

In some embodiments, to determine the set of values, the first AP identifies the at least one capability or operation parameter of the request. In such embodiments, the first AP further determines at least one additional capability or operation parameter not identified by the request and determines values of the at least one capability or operation parameter of the request and the at least one additional capability or operation parameter, wherein each of the values are included in the set of values.

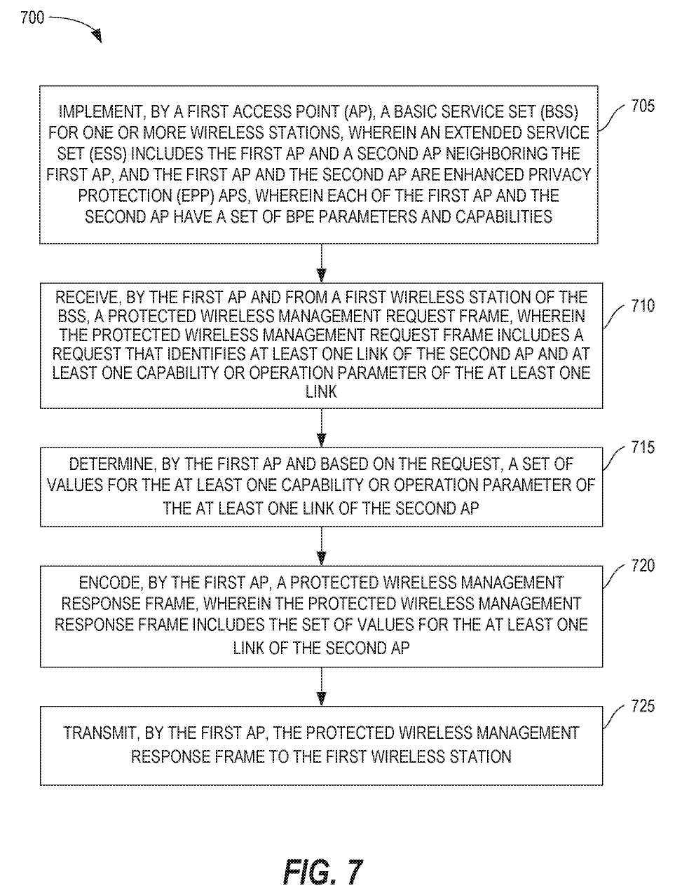

FIG. 7 depicts an example method 700 for identifying capability and operation parameter values for a neighboring EPP AP in a different BSS than a requesting wireless STA, according to some embodiments of the present disclosure. In some aspects, the method 700 is performed by an AP, such as an AP 110 of FIG. 1 and/or an AP 210 of FIG. 2.

At block 705, a first AP (e.g., any of the APs 110 of FIG. 1 and/or the AP 210 of FIG. 2) implements a BSS (e.g., any of BSSs 105 of FIG. 1) for one or more wireless stations (e.g., any of the STAs 115 of FIG. 1 residing within the same BSS 105 of the first AP and/or the STA 215 of FIG. 2), wherein an ESS includes the first AP and a second AP neighboring the first AP (e.g., any of the APs 110 of FIG. 1 residing within a different BSS 105 than the first AP), and the first AP and the second AP are EPP APs, wherein each of the first AP and the second AP have a set of capabilities and operation parameters.

At block 710, the first AP receives, from a first wireless station of the BSS, a protected wireless management request frame (e.g., the query 205 of FIG. 2), wherein the protected wireless management request frame includes a request that identifies at least one link of the second AP and at least one capability or operation parameter of the at least one link. In some examples, block 710 may correspond to, or provide additional or alternative details for, the operations discussed above with reference to block 305 of FIG. 3 or block 405 of FIG. 4.

At block 715, the first AP determines (e.g., using, or in conjunction with, a component therein, such as the parameter component 112 of FIG. 1 or the parameter component 212 of FIG. 2), based on the request, a set of values for the at least one capability or operation parameter of the at least one link of the second AP. In some examples, block 610 may correspond to, or provide additional or alternative details for, the operations discussed above with reference to block 315 or block 320 of FIG. 3, or block 415 of FIG. 4 (with additional details described by blocks 505-530 of FIG. 5).

At block 720, the first AP encodes a protected wireless management frame, wherein the protected wireless management frame includes the set of values for the at least one link of the second AP. In some examples, block 715 may correspond to, or provide additional or alternative details for, the operations discussed above with reference to block 325 of FIG. 3 or block 420 of FIG. 4.

At block 725, the first AP transmits the protected wireless management frame (e.g., as, or within, the response 220 of FIG. 2) to the first wireless station of the BSS. In some examples, block 725 may correspond to, or provide additional or alternative details for, the operations discussed above with reference to block 330 of FIG. 3 or block 430 of FIG. 4.

In some embodiments, the request includes a neighbor report request identifying the second AP.

In some embodiments, the request includes at least one of a request element or an extended request element identifying the at least one capability or operation parameter for which the first AP should determine a value for.

In some embodiments, the request includes a flag indicating a full profile request. In such embodiments, to determine the set of values, the first AP determines a value for each capability or operation parameter of the second AP. In some examples, said operations may correspond to, or provide additional or alternative details for, the operations discussed above with reference to block 315 of FIG. 3 or block 515 of FIG. 5.

In some embodiments, the second AP is an AP MLD comprising a plurality of links. In some embodiments, the request may include at least one link of the plurality of links. In some embodiments, the request comprises an ML element that includes one or more per-STA profile sub-elements, wherein each of the one or more per-STA profile sub-elements identifies a link of the plurality of links of the second AP for which the first AP should determine a value for. In some embodiments, each per-STA profile sub-element comprises at least one of a request element or an extended request element identifying the at least one capability or operation parameter for which the first AP should determine a value for.

In some embodiments, to determine the set of values, the first AP identifies the at least one capability or operation parameter of the request. In such embodiments, the AP further determines at least one additional capability or operation parameter not identified by the request and determines values of the at least one capability or operation parameter of the request and the at least one additional capability or operation parameter, wherein each of the values are included in the set of values.

In some examples, to determine the set of values, the first AP receives values for the identified at least one capability or parameter from the second AP.

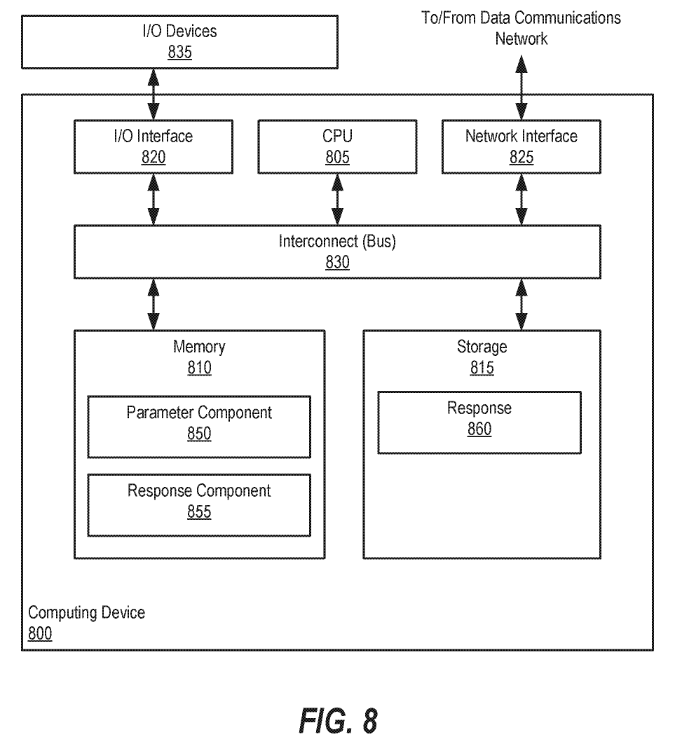

FIG. 8 depicts an example network device 800 configured to perform various aspects of the present disclosure, according to some embodiments of the present disclosure. Although depicted as a physical device, in embodiments, the computing device 800 may be implemented using any number of virtual or physical device(s) (e.g., in a cloud environment). In one embodiment, the computing device 800 corresponds to or implements an AP, such as any of the APs 110 or the AP 210 of FIGS. 1 and 2, respectively, or the APs discussed above with reference to FIGS. 3-7.

As illustrated, the computing device 800 includes a CPU 805, a memory 810, a storage 815, a network interface 825, and one or more I/O interfaces 820. In the illustrated embodiment, the CPU 805 retrieves and executes programming instructions stored in the memory 810, as well as stores and retrieves application data residing in the memory 810, the storage 815, or both. The CPU 805 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, the memory 810, the network interface(s) 825, and the I/O interface(s) 820 are communicatively coupled by one or more buses 830.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 is generally included to be representative of a random-access memory. The memory 810 may store processor-executable software code containing instructions that, when executed by the CPU 805, enable the computing device 800 to perform various functions described herein for wireless communication. The memory 810 may include random access memory (RAM) and read-only memory (ROM).

As depicted, the memory 810 includes a parameter component 850 and a response component 855. Although depicted as discrete components for conceptual clarity, in embodiments, the operations of the depicted components (and others not illustrated) may be combined or distributed across any number of components. Further, although depicted as software residing in the memory 810, in embodiments, the operations of the depicted components (and others not illustrated) may be implemented using hardware, software, or a combination of hardware and software.

The parameter component 850 may generally correspond, and operate in a similar manner to, the parameter component 112 of any of the APs 110 of FIG. 1 or the parameter component 212 of the AP 210 of FIG. 2. The parameter component 850 may be configured to analyze a request (e.g., the query 205 of FIG. 2) to determine what capabilities and/or operation parameters need values determined for and may subsequently determine the respective values.

The response component 855 may generally correspond, and operate in a similar manner to, the response component 213 of the AP 210 of FIG. 2. The response component 855 may generate one or more frames or responses, such as the response 860, to STAs (e.g., STA 110 of FIG. 1), providing STAs with requested information on various capabilities and/or operation parameters of a target AP. Although depicted as residing in the storage 815, the response 860 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a first access point (AP) and from a first wireless station associated to the first AP, a protected wireless management request frame, wherein the first AP is an Enhanced Privacy Protection (EPP) AP, and wherein the protected wireless management request frame includes a request that identifies at least one link of the first AP and at least one capability or operation parameter of the at least one link;
determining, by the first AP and based on the request, a set of values for the at least one capability or operation parameter of the at least one link of the first AP;
encoding, by the first AP, a protected wireless management response frame, wherein the protected wireless management response frame includes the set of values for the at least one link of the first AP; and
transmitting, by the first AP, the protected wireless management response frame to the first wireless station.

2. The method of claim 1, wherein the request includes at least one of a request element or an extended request element identifying the at least one capability or operation parameter for which the first AP should determine a value.

3. The method of claim 1, wherein the request includes a flag indicating a full profile request, and wherein determining the set of values to provide to the first wireless station includes determining a value for each capability or operation parameter of the first AP.

4. The method of claim 1, wherein the first AP is an AP multi-link device (MLD) comprising a plurality of links, and wherein the request includes at least one link of the plurality of links.

5. The method of claim 4, wherein the request comprises a multi-link (ML) element that includes one or more per-STA profile sub-elements, wherein each of the one or more per-STA profile sub-elements identifies a link of the plurality of links of the first AP for which the first AP should determine a value.

6. The method of claim 5, wherein each per-STA profile sub-element comprises at least one of a request element or an extended request element identifying the at least one capability or operation parameter for which the first AP should determine a value.

7. The method of claim 1, wherein determining the set of values includes:
identifying the at least one capability or operation parameter of the request;
determining at least one additional capability or operation parameter not identified by the request; and
determining values of the at least one capability or operation parameter of the request and the at least one additional capability or operation parameter, wherein each of the values are included in the set of values.

8. A method, comprising:
implementing, by a first access point (AP), a basic service set (BSS) for one or more wireless stations, wherein:
an Extended Service Set (ESS) includes the first AP and a second AP neighboring the first AP, and
the first AP and the second AP are Enhanced Privacy Protection (EPP) APs, wherein each of the first AP and the second AP have a set of capabilities and operation parameters;
receiving, by the first AP and from a first wireless station of the BSS, a protected wireless management request frame, wherein the protected wireless management request frame includes a request that identifies at least one link of the second AP and at least one capability or operation parameter of the at least one link;
determining, by the first AP and based on the request, a set of values for the at least one capability or operation parameter of the at least one link of the second AP;
encoding, by the first AP, a protected wireless management response frame, wherein the protected wireless management response frame includes the set of values for the at least one link of the second AP; and
transmitting, by the first AP, the protected wireless management response frame to the first wireless station.

9. The method of claim 8, wherein the request includes a neighbor report request identifying the second AP.

10. The method of claim 8, wherein the request includes at least one of a request element or an extended request element identifying the at least one capability or operation parameter for which the first AP should determine a value.

11. The method of claim 8, wherein the request includes a flag indicating a full profile request, and wherein determining the set of values to provide to the first wireless station includes determining a value for each capability or operation parameter of the second AP.

12. The method of claim 8, wherein the second AP is an AP multi-link device (MLD) comprising a plurality of links, and wherein the request includes at least one link of the plurality of links.

13. The method of claim 12, wherein the request comprises a multi-link (ML) element that includes one or more per-STA profile sub-elements, wherein each of the one or more per-STA profile sub-elements identifies a link of the plurality of links of the second AP for which the first AP should determine a value for.

14. The method of claim 13, wherein each per-STA profile sub-element comprises at least one of a request element or an extended request element identifying the at least one capability or operation parameter for which the first AP should determine a value for.

15. The method of claim 8, wherein determining the set of values includes:
identifying the at least one capability or operation parameter of the request;
determining at least one additional capability or operation parameter not identified by the request; and
determining values of the at least one capability or operation parameter of the request and the at least one additional capability or operation parameter, wherein each of the values are included in the set of values.

16. The method of claim 8, wherein determining the set of values comprises receiving, by the first AP, the set of values for the at least one capability or operation parameter of the at least one link of the second AP from the second AP.

17. An access point (AP), comprising:
one or more processors; and
memory configured to execute an application which, when executed by the one or more processors, performs an operation comprising:
receiving, from a first wireless station associated to the AP, a protected wireless management request frame, wherein the protected wireless management request frame includes a request that identifies at least one link of the AP and at least one capability or operation parameter of the at least one link;
determining, based on the request, a set of values for the at least one capability or operation parameter of the at least one link of the AP;
encoding a protected wireless management response frame, wherein the protected wireless management response frame includes the set of values for the at least one link of the AP; and
transmitting the protected wireless management frame to the first wireless station of the AP.

18. The AP of claim 17, wherein the request includes at least one of a request element or an extended request element identifying the at least one capability or operation parameter for which the AP should determine a value for.

19. The AP of claim 17, wherein the AP is an AP multi-link device (MLD) comprising a plurality of links, and wherein the request includes at least one link of the plurality of links.

20. The AP of claim 17, wherein determining the set of values includes:
identifying the at least one capability or operation parameter of the request;
determining at least one additional capability or operation parameter not identified by the request; and
determining values of the at least one capability or operation parameter of the request and the at least one additional capability or operation parameter, wherein each of the values are included in the set of values.
